(19) United States
(12) Patent Application Publication
(10) Pub. No.: US 2012/0189992 A1
(43) Pub. Date: Jul. 26, 2012

(54) Apparatus And Method For Establishing Standards For Visual Residue Limits

(75) Inventors: Carl Craig, Evergreen, CO (US); William McHale, Centennial, CO (US)

(73) Assignee: WATERS TECHNOLOGIES CORPORATION, Milford, MA (US)

(21) Appl. No.: 13/383,613

(22) PCT Filed: Jul. 16, 2010
(86) PCT No.: PCT/US10/42238

§ 371 Date: Mar. 8, 2012

Related U.S. Application Data
(60) Provisional application No. 61/227,921, filed on Jul. 23, 2009.

(51) Int. Cl. G09B 19/00

(52) U.S. Cl. 434/219

(57) ABSTRACT

Embodiments of the present invention are directed to apparatus and methods for establishing standards for visual residue limits, training individuals to visually observe and recognize surfaces exceeding or complying with residue limits, and certifying individuals for such detection limits The invention features a kit comprising an assembly of coupons with predetermined loads.

### CROSS REFERENCE RELATED TO PATENT APPLICATIONS

This application claims benefit of and is a continuation of to U.S. Provisional Application No. 61/227,921, filed Jul. 23, 2009. The contents of these applications are expressly incorporated herein by reference in its entirety.

### FIELD OF THE INVENTION

Embodiments of the present invention are directed to apparatus and methods for establishing standards for visual residue limits, training individuals to visually observe and recognize surfaces exceeding or complying with residue limits, and certifying individuals for such detection limits. Visual residue limits are used in manufacturing processes to determine cleanliness

### BACKGROUND OF THE INVENTION

For the purpose of clarity, the following terms and words will be used in a defined sense unless the context in which the term or word is used requires a different meaning.

As used herein, the term “visual residue limits” refers to the amount of residue on a surface that an individual can detect by observation with the naked eye or the naked eye assisted with normal and customary individual vision acuity aids. We will use the term normal and customary individual acuity aids to refer to glasses and contact lenses, and excluding complex optical systems such as microscopes, magnification devices, electronically assisted optical sensors. The term represents the point or boundary between “clean” and “dirty” as observed visually by an individual.

The term “surface” refers to the exposed material which is part of a work piece or tool. For example, without limitation, the term “working surface” refers to one or more walls, edges, spouts and the like of vessels, kettles, tables, drums, pots, conduits, pipes, conveyors, sensors, used in manufacturing, synthesis, mixing, heating, cooling, drying, conveying, storage, reacting, quality control, measuring and analysis processes involving chemicals, foodstuffs, feeds, beverages, drugs, fertilizers, and other materials.

The term “residue” refers to material that is not an integral part of the surface. It is removable. For example, without limitation, the term encompasses dust, dirt, soil, stain, materials used in prior uses, cleaning materials, such as soaps, detergents, disinfectants, degradation by-products of cleaning or manufacturing processes, solvents, rinses, industrial lubricants and other undesired materials. The amount of such residue, measured by weight or by parts per million or parts per unit of area, is referred to as “load”. A “clean” face is one in which there is no observable residue.

Coupons are solid forms having a surface which resembles the surface to which the forms are compared or which the forms are substitutes for. The surface which is observed is referred to in this sense as the “viewing surface”. The viewing surface is preferably of the same composition and texture of the process or working surface to which it is intended to resemble.

A “kit”, as used herein, refers to an article of manufacture having a collection of parts and elements including instructions for use. Kits generally contain the collection of parts and elements in suitable packaging known in the art, such as bags, boxes, tethers plastic wraps, “clam-shells” and the like.

Good manufacturing processes (GMP), the Code of Federal Regulation with respect to food and drug processes and state and local laws, codes and ordinances require manufacturers to visually inspect working surface for contamination. That is, those working in these industries are required to maintain certain levels of cleanliness. However, visual inspections may seem objective with arbitrary judgments because of the differences in an individual's ability to discern residues on working surfaces.

It is desirable to have reproducible consistent visual detection limits and to have individuals trained and qualified to such visual detection limits.

### SUMMARY OF THE INVENTION

Embodiments of the present invention are directed to articles of manufacture and methods for establishing reproducible, consistent visual detection limits and to have individuals trained and qualified to such visual detection limits. One embodiment of the present invention is directed to a kit for determining an individual's ability to determine loads on surfaces by visual inspection. The kit comprises a plurality of coupons and instructions. Each of the coupons has a viewing face having a coupon surface corresponding to a working surface for which visual residue determinations are desired. Each of the plurality of coupons has a load of residue on the viewing face or a clean viewing face. The load on each viewing face is selected such that the viewing faces of said plurality of coupons define a range of load for which visual load determinations are desired. The instructions direct the individual to view the coupons at a predetermined distance and lighting to allow such individual to determine his or her ability to identify a load.

The kit is used to train individuals to determine the limits of visual detection and to develop standards. Preferably, residues are applied to the coupons which correspond to the residue in a particular work environment. For example, without limitation, food processes would preferably use coupons which presented food processing residues. Pharmaceutical manufacturing processes would preferably apply residues to coupons which relate to the drug manufacturing process.

Preferably, the instructions provide directions for creating a statistical sampling of individuals to create standards for visual residue. These instructions preferably specify that the visual detection limits of a statistical sampling, normally at least seven, of the relevant population of individuals be determined. The detection limit of such statistical sampling is preferably the basis for setting the standard for visual residue limits.

A particular test subject's ability, to discern loads, is compared to such standards or if such standards exist or are mandated, to such existing or mandated standard. Mandated standards may exist wherein government regulations, codes and statutes have set a standard for load on a particular surface. Indeed, the individual is thus, preferably, certified to visually detect loads based ability to meet or exceed standards.

One embodiment of the present kit comprises a set of standard coupons, and a set of unknown coupons. The standard coupons have a load which is known or will be known to the viewing individual. The unknown coupons have a load that is unknown to the viewing individual. The viewing individual is directed by instructions to match the unknown coupons to the standard coupons based on the viewing individual's opinion as to load. Each of the unknown coupons has indicia which are keyed to actual load on the unknown coupons. The viewing individual's opinion is compared to the keyed results to determine the ability of the individual to identify load on surfaces.

Preferably, the coupons have at least one non-viewing face. The non-viewing face has a marking indicating the load. Thus, the viewing individual is not aware of the load unless reference is made to the marking. The marking allows the plurality of coupons to be arranged in a pattern of increasing or decreasing loads.

Preferably, the kit further comprises a background element. The background element has a standard color and texture upon which the coupons are placed for observing said coupons. The background element is chosen to resemble the environment in which individuals observe working surfaces or to provide a consistent background for testing individuals with respect to each other.

A preferred background element has positions for the coupons to place the plurality of coupons in at least one of two conformations selected from the group consisting of a linear progression and randomized. These positions allow an individual to be trained and evaluated as ability to identify loads in a controlled reproducible manner.

A preferred kit further comprising an housing for storing and containing the coupons. The coupons are preferably carrying a load selected from one or more of the group consisting of soil, manufacturing product and residues, and degradation by-products. The load may be altered by handling and environmental interference. The housing has a base to which the coupons are affixed and a cover defining a chamber for containing said coupons. Preferably, the cover has an open position and a closed position. In the closed position, the housing is used for storing the coupons; and, in an open position, the coupons are arranged for viewing. A preferred housing has a base comprising a background element.

Preferably, the housing has lighting to permit illumination of the plurality of coupons in a light resembling the work place in which working surfaces are viewed.

Preferably, the kit comprises a computer device. The computer has input means and memory to record the viewing individual's ascribing the load on the coupons such that the record may be compared with standards.

A preferred computer device has one or more programs to suggest placement of unknown coupons in a random manner.

A further embodiment of the present invention is directed to a method of establishing visual residue limits. The method comprises the steps of providing a plurality of coupons. Each of the coupons has a viewing face having a coupon surface corresponding to a working surface for which visual residue determinations are desired. Each of the plurality of coupons has a load of residue on the viewing face or is clean. And, the load on each viewing face of each of the coupons is selected such that the viewing faces of the plurality of coupons define a range of load for which visual load determinations are desired. The method further comprises the step of viewing the coupons at a predetermined distance and lighting to determine the individual's ability to identify a load on the viewing face.

Preferably, the method comprises the step of comparing an individual's ability to discern loads to standards. The standards are selected from the group consisting of mandated standards, existing standards, or standards created by statistical sampling of a plurality of individuals. One embodiment of the present method provides the step of statistical sampling a plurality of individuals to create standards for visual residue.

Embodiments of the present method are reproducible such that individuals with the ability to visually detect loads that meet or exceed standards can be certified.

Preferably, the method of the present invention is performed with the article of manufacture as previously described.

These and other features and advantages of the present invention will be apparent to those skilled in the art upon viewing the Figures and reading the detailed description that follows.

### BRIEF DESCRIPTION OF THE DRAWINGS

FIG. 1 depicts an article of manufacture embodying features of the present invention;

FIGS. 2a and 2b depict an article of manufacture embodying features of the present invention; and,

FIG. 3 depicts a statistical analysis embodying features of the present invention;

### DETAILED DESCRIPTION OF THE INVENTION

Embodiments of the present invention will now be described with respect to the preferred embodiments and the best mode with the understanding that such best mode and preferred embodiments are capable of being modified and altered. For example, without limitation, the invention will be described with respect to its relationship to pharmaceutical manufacturing processes with the understanding that the invention has broader applications wherever visual inspections are desired. Embodiments of the present invention are directed to articles of manufacture and methods for establishing reproducible, consistent visual detection limits and to have individuals trained and qualified to such visual detection limits.

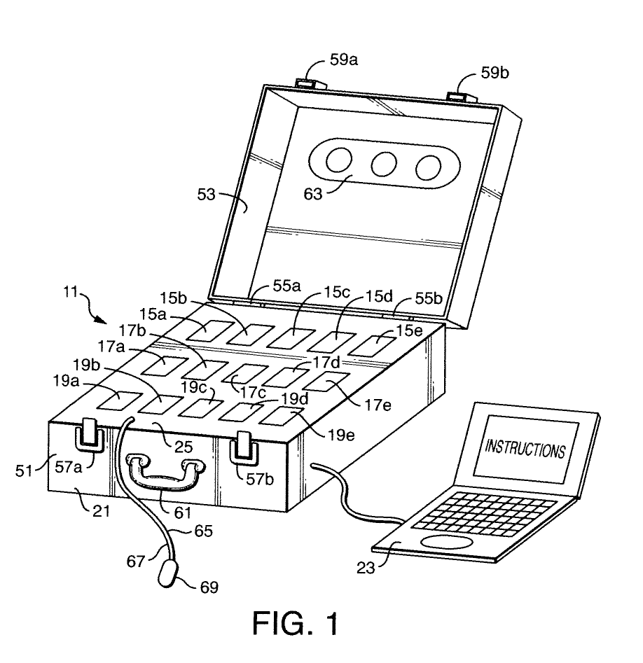

Turning now to FIG. 1, an article of manufacture, a kit, generally designated by the numeral 11, embodying features of the present invention, is depicted. The kit 11 is for determining an individual's ability to identify loads on surfaces by visual inspection. The kit 11 has the following major elements: a plurality of coupons 15a-15e, 17a-17e, and 19a-19e, housing 21, computer device 23 with instructions, and a background element 25.

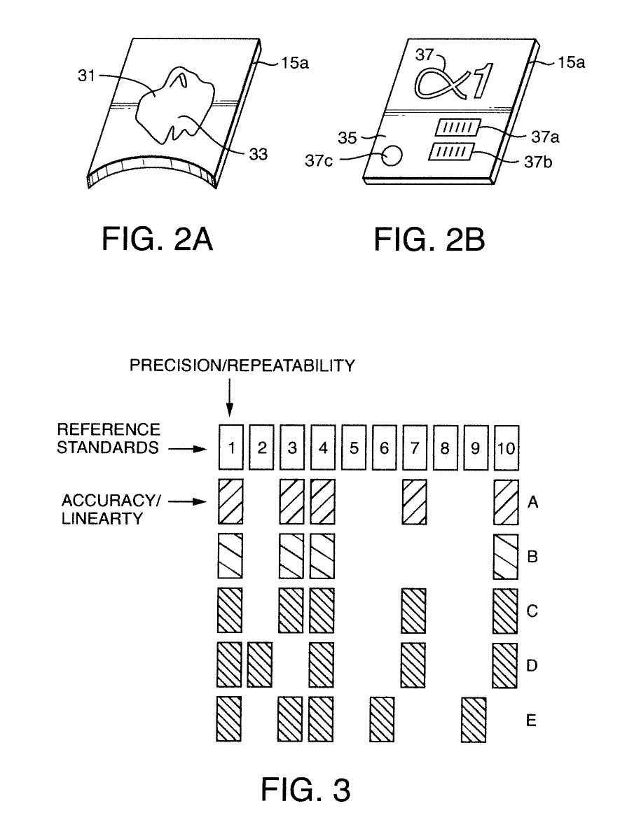

Each of the coupons 15a-15e, 17a-17e, and 19a-19e has a viewing face, which is the face of the coupon which the reader is observing in FIG. 1. This viewing face, which is identified by numeral 31, is depicted with respect to a single coupon 15b in FIG. 2a. The viewing face 31 is a coupon surface corresponding to a working surface [not shown] for which visual residue determinations are desired. The work surface may be any solid surface, typically a metal such as steel, stainless steel, iron, aluminum, brass, tin, or rubbers, ceramics or plastics, or glasses. For example, without limitation, many pharmaceutical processes are performed in steel or stainless steel reaction vessels. For the purpose of this example, the coupon is made of stainless steel.

Each of the plurality of coupons has a load 33 of residue on the viewing face or a clean viewing face [not shown]. The load 33 on each viewing face is selected such that the viewing faces of said plurality of coupons define a range of load for which visual load determinations are desired and preferably encompass a range, both higher and lower, of loads for which the human eye may detect, or which the viewing individual is to be tested. Returning now to FIG. 1, coupons 15a-15e comprise a clean coupon 15a, and coupons 15b through 15e, in which coupons 15b-15e each bearing a different load 33 within the range of loads 33 for which detection is desired. It should be noted that in the event a “clean” surface is not within the desired range, coupon 15a may, in the alternative, bear a load 33.

Returning again to FIGS. 2a and 2b, the load 33 is preferably deposited on the viewing face in a manner analogous to that in which it would be likely encountered on a working surface. Preferably, residues are applied to the coupons, such as coupon 15b, which correspond to the residue in a particular work environment. For example, the coupon 15b would bear a load 33 corresponding to a drug manufacturing step in the event the coupons 15a-15e, 17a-17e, and 19a-19e were intended for use in such industry. For example, without limitation, if the coupon 15b related to a food process, the coupon 15b would preferably bear a load 33 corresponding to food processing residues.

The loads 33 are measured and distributed over the viewing surface 31 by spraying or by applications of liquid containing the load 33 and the liquid evaporated or by other suitable means known in the art.

Each coupon, coupons 15a-15e, 17a-17e, and 19a-19e, have at least one non-viewing face 35 as best seen with respect to coupon 15b in FIG. 2b. The non-viewing face 35 has a marking 37 indicating the load. This marking 37 may relate to a keyed table to which the user will refer. The marking 37 may a bar code 37a, or a digital encoded mark 37b or a sensor 37c readable by the computer 23 by sensing devices [not shown] known in the art.

Thus, the viewing individual is not aware of the load 33 unless reference is made to the marking 37. The marking 37 allows the plurality of coupons 15a-15e, 17a-17e, and 19a-19e to be arranged in a pattern of increasing or decreasing loads. The marking 37 also allows the coupons 15a-15e, 17a-17e, and 19a-19e or a subset of the coupons to be arranged in a random manner to be sorted by the viewing individual.

One embodiment of the present kit comprises a set of standard coupons, and a set of unknown coupons. For example, without limitation, returning now to FIG. 1, the standard coupons are the top row coupons, coupons 15a-15e. Standard coupons 15a-15e have a load which is known or will be known to the viewing individual.

The unknown coupons comprise coupons 17a -17e and 19a-19e. Coupons 17a-17e and 19a-19e have a load that is unknown to the viewing individual. Coupons 17a-17e and 19a-19e are placed in a random order. The random order is dictated by instructions which will direct an operator of the kit 11 to place the coupons 17a-17e and 19a-19e in certain positions for evaluation of a viewing individual.

Background element 25 is depicted in FIG. 1 in or on housing 21. The background element 25 has a standard color and texture upon which the coupons are placed for observing said coupons 15a-15e, 17a-17e, and 19a-19e. The background element 25 is chosen to resemble the environment in which individuals observe working surfaces or to provide a consistent background for testing individuals with respect to each other.

Background element 25 has positions for the coupons 15a-15e, 17a-17e, and 19a-19e, to place the plurality of coupons in at least one of two conformations selected from the group consisting of a linear progression and randomized. These positions preferably have sensors [not shown] for reading markings 37. These sensors are placed in signal communication with computer 23. As used herein, the term signal communication means wired for electromagnetic communication or optically linked for photo-communication or linked by wireless communication devices operating on infrared or electromagnetic radio transmission. The background element 25 provides a controlled reproducible environment to allow an individual to be trained and evaluated as ability to identify loads 33.

For example, wherein coupons 15a-15e are standards in linear progression, a viewing individual is directed to assign randomized coupons 19a-19e to a similar position in linear progression in spaces designated 17a -17e. The results are recorded in the computer 23.

Housing 21 is for storing and containing the coupons 15a-15e, 17a-17e, and 19a-19e. The coupons 15a-15e, 17a-17e, and 19a-19e are preferably carrying a load 33 selected from one or more of the group consisting of soil, manufacturing product and residues, and degradation by-products. The load may be altered by handling and environmental interference and are best maintained in a secure isolated container. The housing 21 has a base 51 and a cover 53. As illustrated, the base 51 is attached to the cover 53 by suitable hinges 55a and 55b. Housing 21 has suitable cooperating clasps 57a and 57b and knobs 59a and 59b to secure in a closed position [not shown]. A handle 61 facilitates carrying the kit 11. In a closed position the housing 21, base 51 and cover 53 define a chamber for containing coupons 15a-15e, 17a-17e, and 19a-19e and the background element 25.

In an open position, the housing 21, base 51 and cover 53 allow viewing of coupons 15a-15e, 17a-17e, and 19a-19e. As illustrated, the housing 21 has a light source 63 to provide illumination. A preferred light source 63 permit illumination of the plurality of coupons 15a-15e, 17a-17e, and 19a-19e in a light resembling the work place in which working surfaces are viewed.

Housing 21 has a measuring device 65 to allow the viewing individual to place his eyes at a defined distance. Measuring device 65 comprises a tether 67 and a fob 69 which the viewing individual will use to place his or her face.

Computer device 23 is illustrated as a portable computer 23 in the nature of a lap top. However, those skilled in the art will readily recognize that computer device 23 can be integrated into the housing 21 in the form of computational processing units (CPUs), mainframe computers, desk top computers, servers, and the like. The instructions are depicted as part of the computer device 23 programming. However, those skilled in the art will readily recognize that the instructions can be in printed form and the process performed as a manually or with limited use of computers.

The computer device 23 has input means and memory to record the viewing individual's ascribing the load 33 on the coupons 17a-17e, and 19a-19e, based on standards, coupons 15a-15e, such that the record. The viewing individual's answers in this regard are entered on the computer device 23 keypad 71. This record is compared with standards or used to develop standards in a structured reproducible way.

The kit 11 is used to train individuals to determine the limits of visual detection and to develop standards. The instructions or the computer device 23 provide directions for creating a statistical sampling of individuals to create standards for visual residue. These instructions preferably specify that the visual detection limits of a statistical sampling, normally at least seven, of the relevant population of individuals be determined. The detection limit of such statistical sampling is the basis for setting the standard for visual residue limits.

A particular viewing individual's ability, to discern loads 33, is compared to such standards or if such standards exist or are mandated, to such existing or mandated standard. Mandated standards may exist wherein government regulations, codes and statutes have set a standard for load on a particular surface. The viewing individual is certified to visually detect loads based ability to meet or exceed standards in a structured reproducible analysis.

A further embodiment of the present invention is directed to a method of establishing visual residue limits is described with respect to the following Example. The Example describes the operation of the kit 11, with respect to FIG. 3, which features an expanded number of coupons, coupons 115a-115j. The top row represents coupons 115a -115j arranged as a standard set. Five viewing individuals, represented by letter A, B, C, D, and E are directed to place unknown coupons 117a-117j in linear progression corresponding to the standard set to determine the visual residue limit.

The number of participants can vary from a lower limit of seven (minimum accepted number to yield statistically valid results) to any number that might be available. This example features five individuals for simplicity. The more participants there are in a VRL determination effort, the more sound the data are and the better the conclusions are as a result of examining the statistics.

The standard set of coupons, coupons 115a-115j, have different levels of contamination, load 33, or no load, on each viewing face 31. These coupons 115a-115j are prepared as Certified Reference Materials (CRMs) and used to construct a gradient in the top row of FIG. 3. For example, coupons 115a-115j are constructed with a range of concentrations of load 33.

| Coupon | Concentration in μg/cm² |
|---|---|
| 115a | 0.0 |
| 115b | 0.05 |
| 115c | 0.1 |
| 115d | 0.15 |
| 115e | 0.2 |
| 115f | 0.25 |
| 115g | 0.3 |
| 115h | 0.35 |
| 115i | 0.4 |
| 115j | 0.45 |

The method comprises the step of viewing the coupons at a predetermined distance and lighting to determine the individual's ability to identify a load 33 on the viewing face 31.

For purposes of this discussion, the responses to five viewing individuals in the study are denoted A-E. These responses are used to determine the accuracy, linearity, precision, detection limit and reproducibility of the process by examining statistically the number and nature of correct unknown coupon placements by each viewing individual.

As used herein, the term “accuracy/linearity” refers to a statistical measure the correctly matched “unknown” standards to the certified reference materials. The term “Precision/Repeatability” refers to a statistical measure of the number of successfully matched “unknowns” (the exercise was performed successfully “x” number of times with “x” separate lots of unknowns for contamination level or load 33. In the example of FIG. 3 the precision/repeatability measure seems to about at the 0.3 μg/cm² level.

If reference standards 115a, 115c, 115d, 115g and 115h were given to the study participants, and numbers 115b, 115e, 115f, 115i and 115j were not (as an example), the indication may be that the process “breaks down” moving left to right somewhere before or after 115g (0.3 μg/cm²) level, as the incorrect placements rise dramatically after that point. Statistical examining of a large collection of data with input from many participants makes it possible to estimate very accurately the applicability of visual inspections for the contaminant used, and ultimately to determine a visual residue level for the combination of contaminant and material/surface.

The method comprises the step of comparing an individual's ability to discern loads to standards. The standards are selected from the group consisting of mandated standards, existing standards, or standards created by statistical sampling of a plurality of individuals. Embodiments of the present method provide methods and kits for statistical sampling a plurality of individuals to create standards for visual residue. Embodiments of the present method are reproducible such that individuals with the ability to visually detect loads that meet or exceed standards can be certified.

Thus, we have described the present invention with regard to the preferred embodiments and the best mode with the understanding that these embodiments can be altered and modified without departing from the teaching herein. Therefore, the present invention should not be limited to the discussion herein but should encompass the subject matter of the following claims and the equivalents thereto.

We claim:

1. An article of manufacture to be used as a kit for determining an individual's ability to determine loads on surfaces by visual inspection comprising:
a. a plurality of coupons, each of said coupons having a viewing face having a coupon surface corresponding to a working surface for which visual residue determinations are desired, each of said plurality of coupons having a load of residue on said viewing face or a clean viewing face, said load on each viewing face of each of said coupons selected such that said viewing faces of said plurality of coupons define a range of load for which visual load determinations are desired;
b. instructions for viewing the viewing face of said coupons at a predetermined distance and lighting to allow an individual viewing at said predetermined distance and in said lighting to determine said individual's ability to identify a load.

2. The article of manufacture of claim 1 wherein said plurality of coupons are arranged in a pattern of increasing or decreasing loads.

3. The article of manufacture of claim 1 wherein each of said coupons has a marking indicating the load.

4. The article of manufacture of claim 3 wherein said coupon has at least one non-viewing face and said marking is on said non-viewing face.

5. The article of manufacture of claim 1 wherein said load is selected from one or more of the group consisting of soil, manufacturing product and residues, and degradation by-products.

6. The article of manufacture of claim 1 further comprising a housing, said housing having a base to which the coupons are affixed and a cover, said base and cover defining a chamber for containing said coupons, said cover in a closed position storing said coupons and in a open position allowing said viewing face of said coupons to be viewed.

7. The article of manufacture of claim 1 further comprising a background element, said background element having a standard color and texture for observing said coupons.

8. The article of manufacture of claim 7 wherein said background element has positions for said coupons to place said plurality of coupons in at least one of two conformations selected from the group consisting of a linear progression, randomized allowing an individual to be trained and evaluated as ability to identify loads.

9. The article of manufacture of claim 1 wherein said individual's ability to discern loads is compared to standards.

10. The article of manufacture of claim 9 wherein said individual is certified to visually detect loads based ability to meet or exceed standards.

11. The article of manufacture of claim 1 wherein said instructions provide for creating a statistical sampling of individuals to create standards for visual residue.

12. The article of manufacture of claim 1 wherein said plurality of coupons comprise a set of standard coupons, and a set of unknown coupons, said standard coupons are known to the individual as having a load or are clean, and said unknown coupons have a load or are clean and which is unknown to the viewing individual, said viewing individual is directed by instructions to match said unknown coupon with the standard coupons based on the viewing individual's opinion as to load, each of said unknown coupons having indicia which are keyed to actual load and the viewing individual's opinion is compared to determine the ability of the individual to identify load on surfaces.

13. A method of establishing visual residue limits comprising the steps of:
a. providing a plurality of coupons, each of said coupons having a viewing face having a coupon surface corresponding to a working surface for which visual residue determinations are desired, each of said plurality of coupons having a load of residue on said viewing face or a clean viewing face, said load on each viewing face of each of said coupons selected such that said viewing faces of said plurality of coupons define a range of load for which visual load determinations are desired;
ii. viewing the viewing face of said coupons at a predetermined distance and lighting to determine said individual's ability to identify a load.

14. The method of claim 13 wherein said plurality of coupons are arranged in a pattern of increasing or decreasing loads.

15. The method of claim 13 wherein each of said coupons has a marking indicating the load.

16. The method of claim 15 wherein said coupon has at least one non-viewing face and said marking is on said non-viewing face.

17. The method of claim 13 wherein said load is selected from one or more of the group consisting of soil, manufacturing product and residues, and degradation by-products.

18. The method of claim 13 further comprising a housing, said housing having a base to which the coupons are affixed and a cover, said base and cover defining a chamber for containing said coupons, said cover in a closed position storing said coupons and in a open position allowing said viewing face of said coupons to be viewed.

19. The method of claim 13 further comprising a background element, said background element having a standard color and texture for observing said coupons.

20. The method of claim 19 wherein said background element has positions for said coupons to place said plurality of coupons in at least one of two conformations selected from the group consisting of a linear progression, randomized allowing an individual to be trained and evaluated as ability to identify loads.

21. The method of claim 1 comprising the step of comparing an individual's ability to discern loads to standards.

22. The method of claim 21 comprising the step of certifying an individual to visually detect loads based ability to meet or exceed standards.

23. The method of claim 13 comprising the step of statistical sampling a plurality of individuals to create standards for visual residue.

24. The article of manufacture of claim 1 wherein said plurality of coupons comprise a set of standard coupons, and a set of unknown coupons which the viewing individual is directed by instructions to match with the standard coupons based on the viewing individual's opinion as to load, each of said unknown coupons having indicia which are keyed to actual load on said unknown coupons and the viewing individual's selection is compared to determine the ability of the individual to identify load on surfaces.
